(19) United States
(12) Patent Application Publication
(10) Pub. No.: US 2026/0075273 A1
(43) Pub. Date: Mar. 12, 2026

(54) POINT DETECTION IN VIDEO AND DELIVERY OF DELIVERABLE CONTENT

(71) Applicant: Disney Enterprises, Inc., Burbank, CA (US)

(72) Inventor: Fabian Gallusser, Palo Alto, CA (US)

(73) Assignee: Disney Enterprises, Inc., Burbank, CA (US)

(21) Appl. No.: 18/882,715

(22) Filed: Sep. 11, 2024

(51) Int. Cl. H04N 21/258; H04N 21/235; H04N 21/2668

(52) U.S. Cl. CPC H04N 21/25891; H04N 21/235; H04N 21/2668

(57) ABSTRACT

In some embodiments, a method determines user experience information for an instance of main content. The user experience information is based on user experience of users while displaying the instance of main content. The user experience information is analyzed to determine a point of interest in the instance of main content. A type for the point of interest is determined based on a deviation in the user experience information. The method retrieves metadata for the point of interest. The metadata is based on content in the instance of main content that is associated with the point of interest. Deliverable content for the point of interest is determined based on the type and the metadata for the point of interest. The method causes a delivery of deliverable content based on when the point of interest is displayed in the instance of main content. Feedback is used to adjust the deliverable content.

### BACKGROUND

A service may provide the delivery of content to client devices. An instance of main content may be selected by a client device being used by a user, and a content delivery network starts the delivery of the instance of main content to the client device. The user may start to view the instance of main content on the client device once the delivery starts. However, the starting of the playback of the instance of main content does not mean the user will continue to watch the instance of main content. For example, users may stop the delivery before the playback of the instance of main content finishes, such as at the 10 minute, 30 minute, 40 minute, etc. points in a movie. Having a user stop the playback of the instance of main content before finishing watching the content may be a negative event for the service.

### BRIEF DESCRIPTION OF THE DRAWINGS

The included drawings are for illustrative purposes and serve only to provide examples of possible structures and operations for the disclosed inventive systems, apparatus, methods and computer program products. These drawings in no way limit any changes in form and detail that may be made by one skilled in the art without departing from the spirit and scope of the disclosed implementations.

FIG. 1 depicts a simplified system for providing deliverable content based on points of interest in main content according to some embodiments.

FIG. 2 depicts a simplified flowchart for determining deliverable content according to some embodiments.

FIG. 3 depicts a first example of using user experience information to determine deviations in the user experience for an instance of main content according to some embodiments.

FIG. 4 depicts a second example of using user experience information from other instances of content to determine points of interest according to some embodiments.

FIG. 5 depicts an example of determining deliverable content according to some embodiments.

FIG. 6 depicts a simplified flowchart of a method for sending deliverable content according to some embodiments.

FIG. 7 depicts a simplified flowchart of a method for processing feedback for deliverable content according to some embodiments.

FIG. 8 illustrates one example of a computing device according to some embodiments.

### DETAILED DESCRIPTION

Described herein are techniques for a content delivery system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may offer a service in which users can watch content, such as via streaming or delivery of the content. For the service, the starting of the delivery of an instance of main content is a positive indicator. However, another indicator is how long users watched or how many users finished watching the instance of main content (e.g., finished may be measured based on a threshold of a time within the duration of the instance of main content), and might indicate enjoyment of the content, which can be reflected as a positive indicator. If users'stop playback during the instance of main content, this may be a negative event. This may be a negative event for many reasons, for example, it may signal that the content was not as enjoyable as intended, or the viewing experience was suboptimal. The system would like to provide an optimal entertaining viewing experience of the instance of main content. There are also points when the service can use places where the user experience is high to improve the delivery of main content, such as by supplementing the content of a popular scene. The user experience may be information that is based on a number of viewers that viewed the content at a point in time in the delivery of the instance of main content, but other measurements may be used, such as rewind events.

To improve the user experience, a system analyzes user experience information for an instance of main content. The analysis is used to identify points of interest in the instance of main content. For example, the points of interest may be moments that identify key points in the instance of main content. The points of interest may be classified in different types, such as points in which there is a high risk of stopping the playback of the instance of main content, points where there may be engaging moments, points where there may be confusing moments, points where funny events occur, etc.

The system then retrieves metadata for the points of interest. The metadata may describe information for the points of interest, such as describing characteristics for content associated with the points of interest (e.g., the content is a long monologue, a funny scene, etc.). Then, the system determines deliverable content based on the type of point of interest and the respective metadata for the point of interest. The deliverable content may be information that is delivered during the display of the instance of main content. For example, the deliverable content may be displayed with the instance of main content. In some embodiments, the deliverable content may be displayed as an overlay over the main content at a time based on a position in the instance of main content based on the point of interest, such as right before the point of interest is reached in the delivery of the instance of main content, during the point of interest, etc. Other methods of sending the deliverable content may be appreciated, such as sending an email, sending the deliverable content to a second device, etc. In some embodiments, the deliverable content may be configured to improve user experience, such as the deliverable content may be interactive, such as including surveys, trivia questions, quizzes, polls, etc. Other types of deliverable content may also be determined based on the type of the point of interest and metadata for the point of interest.

The addition of deliverable content with the delivery of the instance of main content may improve the delivery of the main content. For example, the user experience may be improved by determining and displaying the deliverable content based on the point of interest. For example, the deliverable content may lead to the main content continuing to be delivered and watched. The determination of the points of interest is important. For example, adding deliverable content should not have a negative effect on the user experience. Accordingly, as will be discussed below, the system may determine points of interest using different processes that identify points of interest that are appropriate for deliverable content to be provided. Also, the type of the point of interest may be determined. Then, the metadata associated with the points of interest is determined. By using the type and the metadata, the system is able to improve the selection of deliverable content, which may improve the relevancy of the deliverable content to the point of interest.

### System

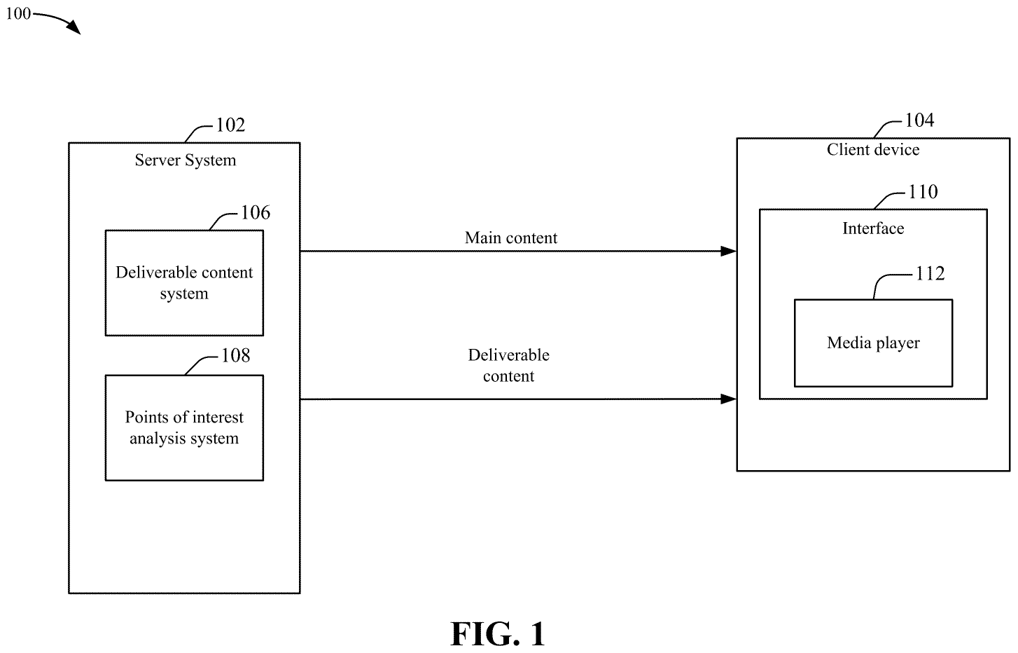

FIG. 1 depicts a simplified system 100 for providing deliverable content based on points of interest in main content according to some embodiments. System 100 includes a server system 102 and a client device 104. Although a single instance of server system 102 and client device 104 are shown, multiple instances may be provided. For example, multiple client devices 104 may be interacting with server system 102. Also, server system 102 may include multiple servers or other computing devices.

Client device 104 may include a mobile phone, smartphone, set top box, television, living room device, tablet device, or other computing device. Client device 104 may include a media player 112 that is displayed on an interface 110. Client device 104 may select main content to playback on media player 112. Although main content is shown as being delivered from server system 102 to client device 104, a separate content delivery network (not shown) may be used to deliver the main content to client device 104.

Server system 102 includes a deliverable content system 106 and a points of interest analysis system 108. Deliverable content system 106 may provide the delivery of deliverable content while the main content is being delivered and displayed at media player 112. Points of interest analysis system 108 may determine points of interest in an instance of the main content. An instance of main content may be a video, such as a movie, show, short, etc., audio, or other content. The instance may be associated with an asset, such as a first video, and a second instance of main content may be associated with a second movie. The main content may be content that was requested by a user of client device 104. Deliverable content may be automatically determined by deliverable content system 106, and not requested by a user. In some embodiments, the user may opt in to receiving deliverable content before the start of the delivery of the instance of content, or before the determination of deliverable content process is started.

Points of interest analysis system 108 may determine points of interest based on user experience information for the main content. For example, the user experience information may be analyzed to determine possible events that may occur during the display of the main content, such as events that end the delivery of the main content, rewind the main content, etc. The user experience information that is used may be based on multiple users that have watched the instance of content.

Points of interest analysis system 108 may determine the deliverable content for respective points of interest. For example, metadata for the points of interest may be retrieved that describes the content of the points of interest. Then, points of interest analysis system 108 may determine deliverable content to include in the delivery of the main content based on the metadata and the user experience information for the point of interest.

Once determining the deliverable content, deliverable content system 106 may send the deliverable content while the main content is being played back. For example, the deliverable content may be displayed as an overlay while the main content is being played back. In some embodiments, interactive or informative content may be displayed over the content of the main content. The content may be different types of content, such as surveys, questions, a QR code, a direct call to action to select a button to expand information, a summary of the point or plot, etc. The main content may be paused until the deliverable content is interacted with by a user or may disappear after a certain amount of time passes. Also, the deliverable content may be sent to a second device, as an email, or sent in other methods of delivery that are separate from the display of the instance of main content.

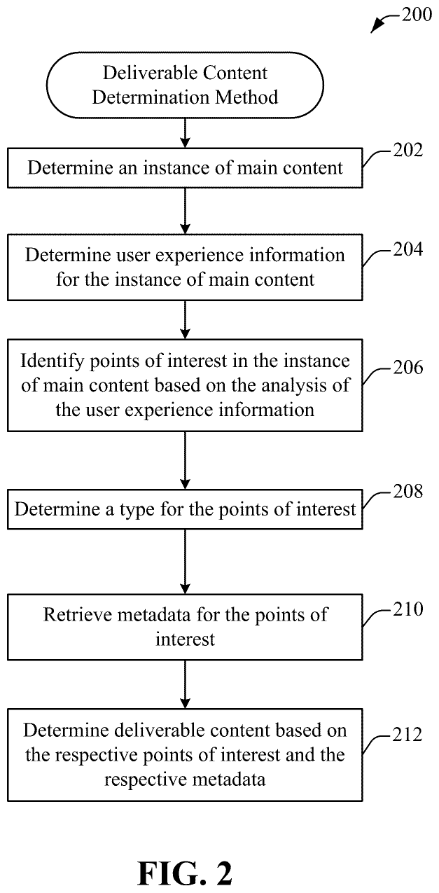

FIG. 2 depicts a simplified flowchart 200 for determining deliverable content according to some embodiments. At 202, server system 102 determines an instance of main content. For example, the service may have a library of instances of main content that may be offered for delivery. Server system 102 may perform the following process for multiple instances of content in the library. Other user experience information may also be used, such as rewind events, fast forward events, etc.

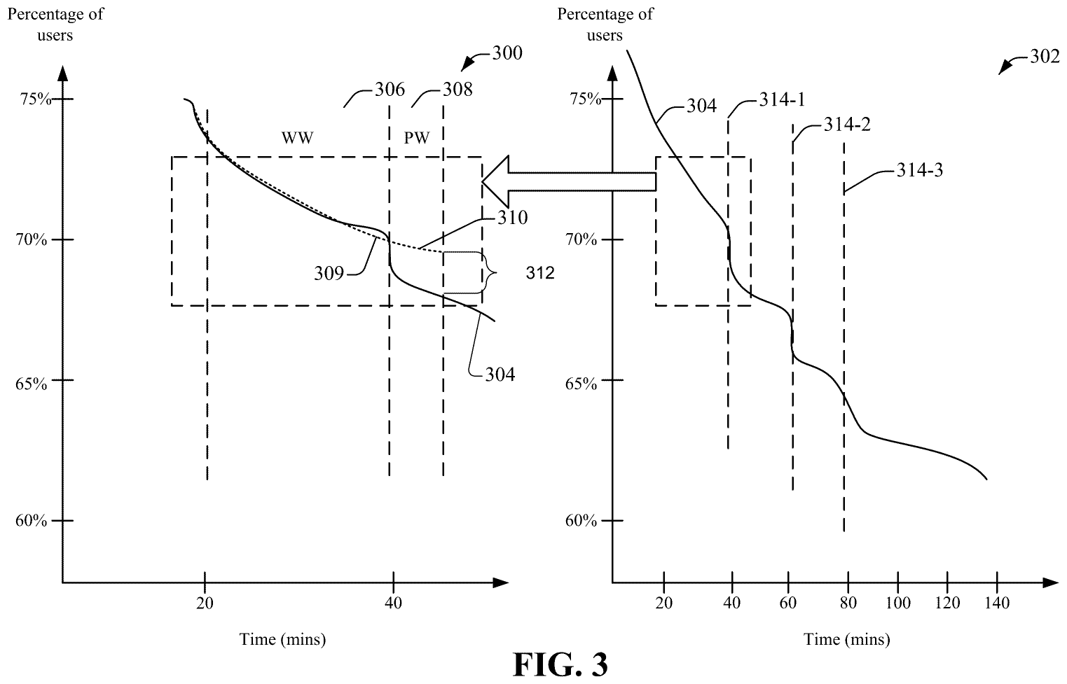

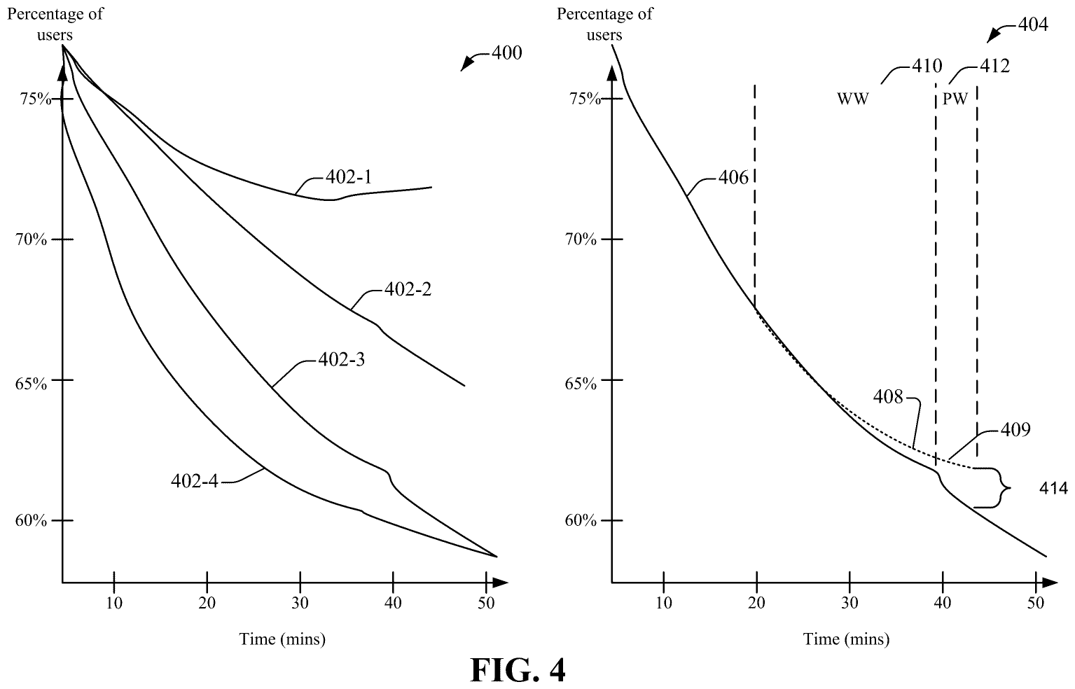

At 204, server system 102 determines user experience information for the instance of main content. The user experience information may be based on historical data for the delivery of the instance of main content that was determined at 202. For example, the user experience information may be a representation (e.g., a curve) that specifies the fraction of users that watched until times found in the duration of the instance of main content. An example of this user experience information will be described in more detail in FIG. 3. Other user experience information may also be based on instances of content other than the instance of main content (e.g., content that is similar to the main content) determined at 202. These instances may be other episodes of a show, other movies in a universe of movies, etc. An example of this user experience information will be described in more detail in FIG. 4. The user experience information may be different than the content found in the instance of main content. For example, the user experience information is based on the delivery of the instance of main content or other instances of content, and not the content found in the instance of main content. For example, the content found in the instance of main content may be two characters are talking in a coffee shop in a scene. The user experience information for this scene may be what percentage of users are watching the instance of main content during the scene.

At 206, server system 102 identifies points of interest in the instance of main content based on the analysis of the user experience information. The analysis may determine deviations in the user experience information. For example, the deviations may be measured when the user experience information deviates by a threshold. The threshold may be measured by a difference in user experience to a prediction in a time period. Also, a threshold may be applied to a change in a rate of the user experience information, or other thresholds may be used. The user experience information may be segmented into different cohorts that have different characteristics, such as different age ranges or other user characteristics. Examples of deviations and thresholds will be described in FIG. 3 and FIG. 4. In some embodiments, the deviations may indicate a change in user experience information that is selected as a point of interest. The reasons for the change in user experience information may include users may stop the delivery of the instance of main content, may rewind the delivery of content to a prior point, or be other changes.

At 208, server system 102 may determine a type for the points of interest. The point of interest may be based on different events. For example, a user may be not interested and stop playback of the instance of main content. A user may also be interested and rewind the instance of main content, such as for a favorite scene or a frequented watched scene. Or, a scene in the instance of main content may be confusing, and the user may rewind. Further, a scene may not be of interest, and the user fast forwards to a next scene. Given the different events, it is important to identify the type for the point of interest. This may affect the deliverable content that may be selected.

The type may be determined in different ways. The points of interest may be classified in one of two categories: increased user experience (scene is rewatched more than expected, typically rewinds, or intentionally skips to) or decreased user experience (scene is skipped, fast forwarded or not watched). For an increased user experience, server system 102 can further split it into more categories. For example, a classic scene is where rewinds occur, but not just rewinds, lots of users starting to stream at that point and leaving right after. A funny moment may be lots of rewinds and nothing else. A difficult/confusing scene may be lots of rewinds but also lots of subtitles being turned on. Metadata about the scenes can also be used to determine what is happening in the scene (e.g., extensive dialogue can be a sign of a key plot explanation that can be confusing). As for decreased user experience, server system 102 may split the types into boring moments and inappropriate moments. Server system 102 might be able to distinguish the two with metadata from the scenes (e.g., boring can be lots of dialogue or very little dialogue, inappropriate can be determined if there is flagged content in the scene, etc.)

At 210, server system 102 retrieves metadata for the points of interest. The metadata may describe content associated with the points of interest. The metadata may be determined by analyzing the content of the instance of main content. Tags for the metadata may be stored and retrieved. Tags may include long monologue, scary scene, etc.

At 212, server system 102 determines deliverable content based on the respective points of interest. The determination of the deliverable content may be based on the type of the point of interest and the metadata for the point of interest. For example, the deliverable content may use the metadata to determine an instance of deliverable content that may improve the type of user experience event that was determined for the point of interest. If the point of interest was determined as a point in which user experience decreased (e.g., the delivery of the instance of main content was stopped), deliverable content to increase the user experience may be determined, such as interactive deliverable content is determined. The increase in user experience may be measured in an increase in viewership of the scene or upcoming scenes. The type of the deliverable content may be based on metadata that describes the content associated with the point of interest. Also, if the point of interest was determined based on users rewinding the playback of the instance of main content to rewatch a scene, the deliverable content may provide more information about the scene because the users may be interested in the scene. This may provide a further increase in user experience, which may be measured in an increase in viewership of the scene or upcoming scenes. The following will now describe the determination of the points of interest and the determination of deliverable content in more detail.

### Points of Interest Determination

User experience information may be used to determine points of interest. The user experience information may be based on different types of metrics. The following may use a metric of a number of users that are watching an instance of main content at times during the duration of the main content. However, other metrics for user experience information may be used, such as rewind events, fast forward events, etc., which will be describe below.

FIG. 3 depicts a first example of using user experience information to determine deviations in the user experience information for an instance of main content according to some embodiments. In a graph 302, points of interest are shown after processing the user experience information for the instance of main content. The Y-axis may be the percentage of users that watched the instance of main content at a given time and the X-axis is a time during the duration of the instance of main content. A curve 304 is a solid line that shows the user experience information that is measured based on the delivery of the instance of main content to client devices 104 being used by users. This user experience information may be based on the actual delivery of the instance of main content being analyzed. The curve may start at 100% when the instance of main content starts to be delivered. As users stop watching the instance of main content, the percentage of users that are watching the instance of main content may fall below 100%. For example, at 20 minutes, around 73 of the users that started watching the instance of main content are still watching. At 50 minutes, around 68% of the users that started watching the instance of main content are still watching, and so on.

A first point of interest is shown at 314-1, a second point of interest is shown at 314-2, and a third point of interest is shown at 314-3. These points of interest are where the user experience information for the instance of main content deviated from the predicted user experience information by more than a threshold. Other points of interest may also be found, but are not shown. In some examples, at point of interest 314-1, a question of “Did you know this song ranks as the best song in the movie?” may be inserted as deliverable content. At point of interest 314-2, a question of “Have you ever heard of Battle Name #1 before watching the movie?” may be inserted as deliverable content. At point of interest 314-3, a question of “Will this character die at the end of the movie?” may be inserted as deliverable content. These questions may increase the user's interest in watching the video and cause them to not end the playback of the video. A multiple choice of answers that a user can select may also be provided as interactive content.

A graph 300 depicts a more detailed depiction of the user experience information for an instance of main content for point of interest 314-1. Different methods may be used to determine deviations in the user experience information. In some embodiments, an analysis window 306 may be used to determine a prediction at 308. In some embodiments, analysis window 306 is a period of time that may be slid across the duration of the instance of main content to determine multiple predictions. Analysis window 306 may be a first period of time and the prediction window 308 may be a second period of time. In this example, prediction window 308 is from 20 minutes to 40 minutes and the prediction may be from 40 minutes to 45 minutes.

Server system 102 analyzes the user experience information for the curve 304 within analysis window 306. Then, server system 102 generates a form of the curve 308 within analysis window 306 and a predicted curve 310 in prediction window 308, both of which are shown as a dotted line. In some embodiments, given a timestamp T, server system 102 fits a functional form of a curve shown at 309 in analysis window 306 using the user experience information of a window width (WW)→T+analysis window 306. Then, server system 102 predicts the curve 310 from T+analysis window 306→prediction window (PW), wherein the prediction window=T+analysis window 306+prediction window 308. The window width may be 20 minutes and the prediction window may be five minutes in this example. Server system 102 then compares the predicted curve 310 with the actual user experience information from curve 304. Server system 102 may determine deviations from the predicted curve 310 and the curve 304 that meet a threshold. For example, deviations that are greater than the threshold may be selected.

At 312, there may be a difference between the curve 304 and the predicted curve 310 that may be greater than a threshold. This point may indicate there was a deviation in user experience (e.g., a larger than usual number of users stopped watching the instance of main content at that point). Then, server system 102 selects this point as a point of interest. The point of interest may be a single time, or a range of time. For example, once the deviation is larger than the threshold, server system 102 may select the point of interest starting at this point. In other embodiments, server system 102 may select the range of time prediction window 308 as the point of interest. Also, server system 102 may select the beginning point where the deviation goes above the threshold and an ending point when the deviation goes below the threshold. Other methods of determining the point of interest may also be appreciated, such as a start time and end time of a scene based on prediction window 308 is used. This process will continue as analysis window 306 is moved across different portions of the instance of main content, such as analysis window 306 may be moved forward by a time, such as one minute, five minutes, etc.

The points of interest may be found using other methods. FIG. 4 depicts a second example of using user experience information from other instances of content to determine points of interest according to some embodiments. A graph 400 shows user experience information for other instances of content. The Y-axis may be the percentage of users that watched the instance of main content at a given time and the X-axis is a time during the duration of the instance of main content.

Curves 402-1, 402-2, 402-3, and 402-4 show respective user experience information for other instances of content. The other instances of content may be selected based on being similar to the present instance of main content, but the other instances of content do not need to be considered similar. The user experience information may be from users that watched the other instances of content.

Server system 102 may combine the curves 402-1 to 402-4 to form a prediction. In some embodiments, the prediction may be a local combination of a portion of the curves 402-1 to 402-4. A graph 404 shows the user experience information for the instance of main content using a curve 406 that is a solid line. A combined curve 406 from curves 402-1 to 402-4 is shown. A first portion of the combined curve may be found in an analysis window 410 and a second portion is found in prediction window 412. Similar to FIG. 3, the portion of the combined curve in analysis window 410 is used to predict the form of a curve 408 in analysis window 410. A predicted curve 409 is determined in prediction window 412 from the form of curve 408. At 414, a deviation from the combined curve 406 and predicted curve 409 that meets a threshold is shown. This deviation may be used to determine a point of interest, such a point of interest may be determined around the 43 minute mark of the instance of main content.

Although the above two processes were used to determine the points of interest, other methods may be used. For example, a model may receive the user experience information for the instance of main content and output points of interest from analyzing the user experience information. Other user experience information may also be used. For example, other playback events may be used, such as rewind events, fast forward events, etc. The rewind events may indicate an increase in user experience to rewatch key scenes. The fast forward events may indicate a decrease in user experience in a current scene that is being skipped. If a certain number of users perform rewind events or fast forward events, then a point of interest may be determined.

After determining the points of interest, server system 102 may determine the deliverable content.

### Deliverable Content

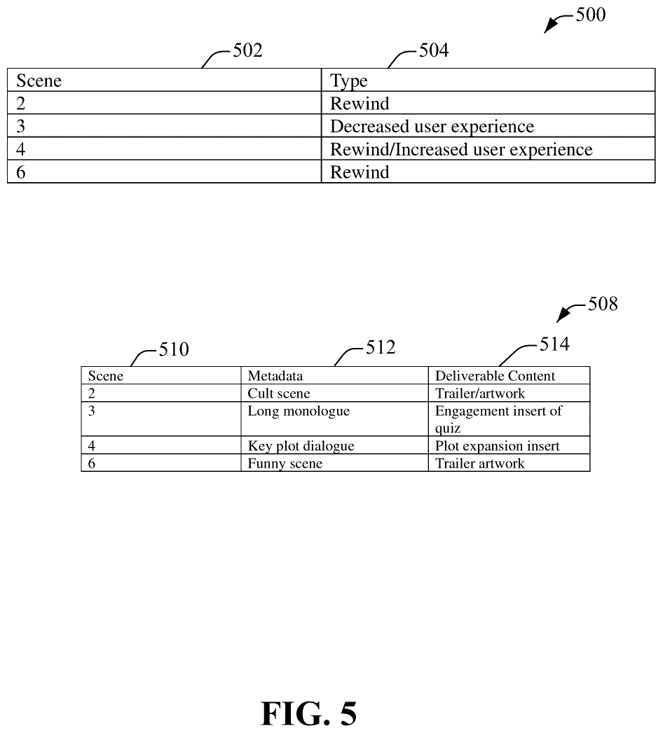

FIG. 5 depicts an example of determining deliverable content according to some embodiments. Different points of interest may be determined for different reasons. The types of points of interest may be based on different what caused the deviation for the point of interest, such as a point of interest that is associated with a drop in user experience information may be determined based on analysis described in FIG. 3 and FIG. 4. Another type of point of interest may be where a portion of the instance of main content, such as a scene, may be rewatched causing a deviation in the user experience during playback that shows high interest. Server system 102 may detect this point of interest based on the rewinding of the instance of main content to rewatch a scene by many users.

Server system 102 may store information for points of interest. A table 500 may identify the points of interest and a type of deviation for the point of interest. For example, column 502 identifies a time in the point of interest in the instance of main content. In this case, a scene may be identified, but other points of interest may be used, such as a time in the playback of the instance of main content. A column 504 identifies the type of deviation, such as a decrease of user experience (e.g., drop of viewership), rewind type event, or increase in user experience (e.g., rewind events). For example, scene 2 may be associated with a rewind type deviation. Here, multiple uses may have rewound the playback to rewatch scene 2. Scene 3 may be associated with a drop in user experience, such as due to the stopping of playback. Scene 4 may be associated with a rewind type event and a drop in user experience. Here, users may have rewound to rewatch scene 4, and users may have stopping watching. Scene 6 may be associated with a rewind type deviation. The type of deviation may be automatically determined based on analyzing the user experience information. For example, a number of playbacks being stopped is determined as a drop in user experience, rewind events are associated with a rewind type, etc.

Metadata may be retrieved from a metadata database based on the point of interest. For example, scenes may be tagged with metadata, and this metadata is retrieved. The metadata may describe the content of the instance of main content based on the point of interest. For example, the content for a scene that includes the point of interest may be determined, and metadata describing the content for the scene is stored in a metadata database. The metadata may be determined in different ways, such as by analyzing the content automatically to determine descriptors for the content via machine learning, manual tagging of content, or other methods.

A table 508 may summarize the scenes in a column 510 and the metadata in a column 512. The rows of table 508 may identify the scene and the metadata that describes the scene. For example, the metadata may describe scene 2 as a cult scene, scene 3 as a long monologue, scene 4 as a key plot dialogue, and scene 6 as a funny scene. The metadata may describe the content found in the scene and not the user experience information for the scene.

Server system 102 may use the metadata and the type of deviation to determine the deliverable content. A column 514 may store an identifier for the deliverable content. Here, for scene 2, a trailer or artwork may be used. The trailer or artwork may be created that includes content from the point of interest because this is a popular scene that was re-watched and the metadata indicates it is a cult scene. Scene 3 includes deliverable content of an user experience insert, which may be an automatically generated quiz. The quiz may be determined because scene 3 is where a drop-off user experience occurred and there is a long monologue. The quiz may help increase user experience in the scene. The deliverable content for scene 4 may be a plot explanation insert, which may be automatically generated from the script of the incident of content. The plot explanation insert may be determined because there is a drop-off in user experience and there is a key plot dialogue. The plot explanation may help users understand the plot dialogue, which may increase the user experience. Scene 6 may include deliverable content of a trailer or artwork. The trailer or artwork may be included because this is a re-watched scene that is funny and could be a good trailer.

Different ways for generating the deliverable content may be appreciated. For example, the deliverable content may be automatically generated using a model, such as a large language model. For example, server system 102 may select the text from subtitles between two timestamps associated with the point of interest. The metadata and the type for the point of interest may also be inputted into the large language model. Then, the large language model may be queried to generate a quiz based on the text included in that window, the metadata, and the type. Different prompts may be generated based on the type of the point of interest and the metadata. For example, prompt templates may be used in which the type, content, and metadata are used to generate the prompt. For example, a prompt may be “What are the interesting facts that you know about movie title #1 to increase user experience for a scene that is about X.” Movie title #1 may be the title of the movie, and X may be content about the scene. The type may be used to determine types of deliverable content to increase user experience. The metadata or content may be used to determine information about the scene. In some examples, for a high rewind type and key plot, the prompt could be oriented as a quiz around “test your knowledge on what has happened so far”. For a cult scene type, server system 102 could determine factoids around the scene (this line is #12 in most famous quotes, were you able to spot the anachronous object in the previous scene). For a nature title watched by young profile, a prompt to generate a simple quiz on key elements shown so far may be determined.

Server system 102 may also generate deliverable content in other ways. For example, server system 102 may use metadata that describes the content, subtitles may be analyzed for popular songs or lyrics, key plot elements may be summarized, questions may be generated from the subtitles or content, or external sources may be used.

The deliverable content may be interactive to increase the user experience. Further, the deliverable content may be automatically generated based on the time of the point of interest in the main content. Also, the point of interest may be used to not perform some actions. For example, advertisements or breaks may not be placed by point of decrease in the user experience. Or, advertisements may be placed after a scene that has a good user experience. Also, actions may be ranked and selected based on the ranking.

### Delivery of the Deliverable Content

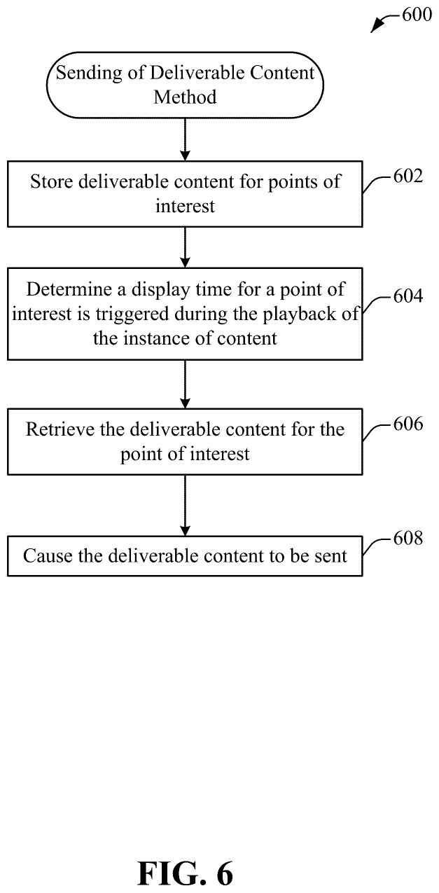

Once the deliverable content is determined, the deliverable content may be sent during the delivery of the instance of main content. FIG. 6 depicts a simplified flowchart 600 of a method for sending deliverable content according to some embodiments. At 602, server system 102 stores the deliverable content for points of interest. For example, after determining deliverable content, server system 102 generates and stores the deliverable content. The deliverable content may be associated with different points of interest, such as scenes or times within the instance of main content.

At 604, server system 102 determines a point of interest is triggered during the playback of the instance of main content. For example, when a point of interest is reached, then the deliverable content should be displayed. The display time may be determined using different methods. For example, the display time may be before the point of interest is reached, when the point of interest is reached, or after the point of interest. If a decrease in the user experience is associated with the point of interest, then the deliverable content may be displayed before the point of interest occurs to hopefully reduce the chance of a drop in the user experience. If the point of interest is a popular point, the deliverable content may be displayed after the point of interest to provide more information after the user views the content at the point of interest.

At 606, the deliverable content is retrieved for the point of interest. For example, server system 102 may determine the deliverable content that is stored for the point of interest, such as an identifier for the deliverable content is retrieved from storage.

At 608, the deliverable content is sent to client device 104. For example, server system 102 may send the deliverable content or cause a content delivery network to send the deliverable content. In some embodiments, the deliverable content is sent to client device 104. Thereafter, client device 104 displays the deliverable content. For example, client device 104 may display the deliverable content as an overlay over the instance of main content. In some embodiments, client device 104 may pause the playback of the instance of main content until an action is received or a time threshold is reached. For example, if a quiz is displayed, an answer to the quiz may restart playback. Also, if the user does not answer the quiz, after a time period, such as three seconds, the playback may restart. Also, client device 104 may also continue playback of the instance of main content. The deliverable content may be delivered in a separate stream that is used as an overlay to the instance of main content. The deliverable content may also be sent to a second device, such as a mobile phone, email for the user, etc.

After the deliverable content is sent, feedback may be received. The feedback may be processed to improve the determination of deliverable content.

### Feedback and Adjustment

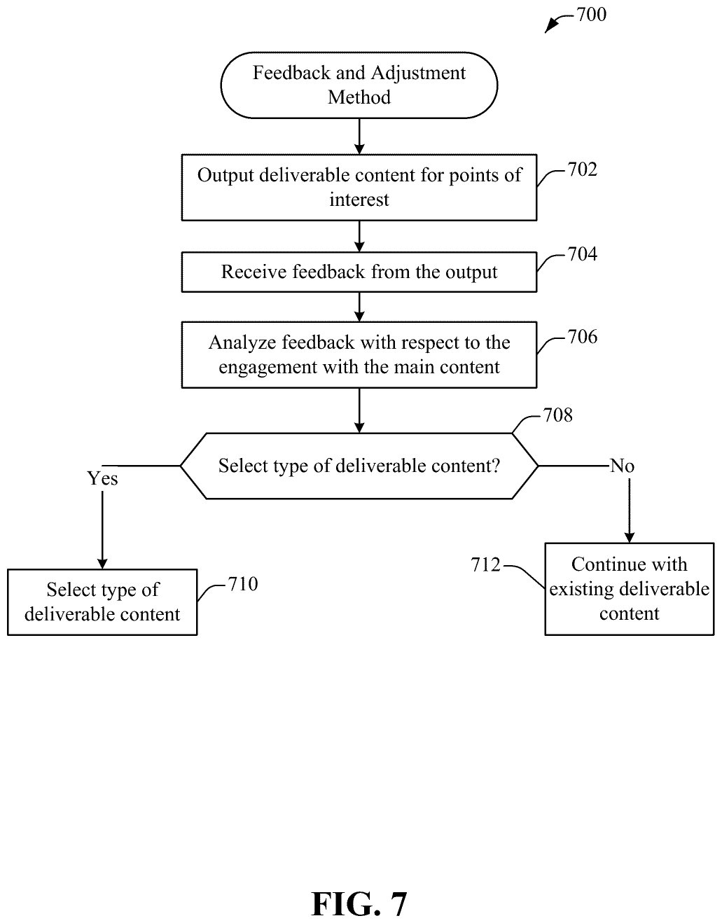

FIG. 7 depicts a simplified flowchart 700 of a method for processing feedback for deliverable content according to some embodiments. In some embodiments, the feedback may be used to adjust the deliverable content that is delivered for a point of interest. For example, the feedback may be used to assign a type of deviation to a point of interest. At 702, server system 102 outputs the deliverable content for points of interest. For example, the deliverable content is displayed at client device 104. In some examples, a plurality of types of deviation may be associated with points of interest. The types may be a rewind type, rewind/cult scene, increased user experience, etc. Then, different types of deliverable content may be determined for the types of deviation. For example, a first type of deliverable content is selected for the rewind type, a second type of deliverable content is selected for the rewind/cult scene, and so on. When a respective point of interest is reached, the type of deliverable content may be selected from the plurality of types of deliverable content (e.g., randomly).

At 704, feedback from the output may be received. Different feedback may be determined. For example, the feedback may measure whether the user experience increased, decreased, or remained the same based on the display of the deliverable content.

At 706, server system 102 analyzes the feedback with respect to the user experience with the main content. For example, if the user experience increases after the display of the deliverable content, then the feedback may be positive. If the user experience drops after the display of the deliverable content or has no effect, then the feedback may be negative. At 708, server system 102 determines whether to adjust the deliverable content. For example, server system 102 may adjust probabilities for the types of deviation based on the feedback. The probabilities may quantify a likelihood the point of interest is associated with the type of deviation.

At 710, server system 102 may determine whether to select a type of deliverable content. For example, the probabilities may be compared to a threshold. If a threshold is met, the type of deviation may be selected, such as a type of deviation may reach a probability of 90 percent.

If an adjustment is not needed, at 712, server system 102 continues with the existing types of deliverable content until a threshold is met. In other embodiments, the threshold may be a time limit, number of times, etc., which if met, the type of deviation with the highest probability may be selected. An adjustment of the deliverable content may be determined. If the user experience does not improve and results in a continued drop-off in user experience, the deliverable content may be changed from one type to another type. Also, if the deliverable content causes a drop in user experience where users have previously rewound to view a scene again, and do not anymore, then the deliverable content may be changed or removed.

In some embodiments, the deliverable content may be used to adjust the type that is assigned to points of interest. Different deliverable content may be delivered, and feedback from the delivery may be used to determine the type. For example, there may be two “types” (A and B). For every point of interest, server system 102 generates two types of deliverable content (type A and type B). For a specific point of interest for main content, based on rules, server system 102 assigned it is type A point of interest with probability 60% and type B point of interest with probability 40%.

During streaming, user 1 reaches that point of interest in the main content. Server system 102 randomly selects one of the two deliverable content with probabilities 60%/40%. It comes up as deliverable content A, which is shown to the user 1. Because the user 1 goes on to complete watching the content, this reinforces the assumption it was a point of interest of type A, and so probabilities are adjusted, now 61% and 39%.

User 2 then reaches the same point of interest in the main content. Server system 102 randomly selects one of the two deliverable content with probabilities 61% /39%. Deliverable content B is selected, which is shown to user 2. Because user 2 does not go on to complete the watching the content, this reinforces the assumption it was a point interest of type A (because type B deliverable content resulted in a negative feedback of not completing watching the content), and so probabilities are adjusted, now 62% and 38%.

User 3 reaches that point of interest while viewing the main content. Server system 102 randomly selects one of the two deliverable content with probabilities 62% /38%. It comes up as deliverable content A, which is shown to user 3. Because user 3 does not go on to complete the stream, this now contradicts the assumption it was a point interest of type A, and so probabilities are adjusted, now back to 61% and 39%. The process can continue with many iterations and feedback, and the probabilities will stabilize, and a clear type for the point of interest may emerge (e.g., 92% /8% for type A/type B). For example, a threshold may be used where the point of interest type is selected automatically. After selection, deliverable content associated with the point of interest may be automatically assigned to the point of interest type, such as deliverable content of type A is assigned to the point of interest. When multiple types of points of interest are determined in this way, training data can be determined. Server system 102 can now build a model that takes as inputs characteristics of the point of interest and can predict the type.

### Conclusion

Accordingly, the combination of determining points of interest, determining the type and metadata for the points of interest, determining deliverable content, and measuring the outcome via feedback may improve the delivery of an instance of main content. The use of the type of point of interest and metadata for the content may improve the deliverable content that is determined. The point of interest may be determined based on user experience information and then the deliverable content may be determined based on the type associated with the point of interest and metadata associated with the content of the instance of main content. This may improve the user experience and the deliverable content that is delivered for the point of interest.

### System

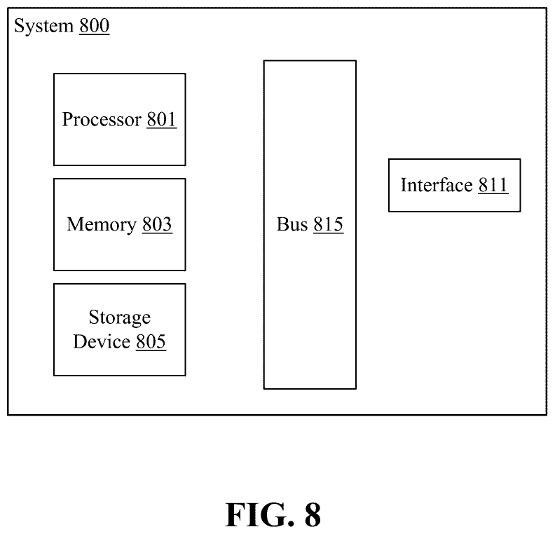

FIG. 8 illustrates one example of a computing device according to some embodiments. According to various embodiments, a system 800 suitable for implementing embodiments described herein includes a processor 801, a memory 803, a storage device 805, an interface 811, and a bus 815 (e.g., a PCI bus or other interconnection fabric.) System 800 may operate as a variety of devices such as server system 102, or any other device or service described herein. Although a particular configuration is described, a variety of alternative configurations are possible. The processor 801 may perform operations such as those described herein. Instructions for performing such operations may be embodied in the memory 803, on one or more non-transitory computer readable media, or on some other storage device. Various specially configured devices can also be used in place of or in addition to the processor 801. Memory 803 may be random access memory (RAM) or other dynamic storage devices. Storage device 805 may include a non-transitory computer-readable storage medium holding information, instructions, or some combination thereof, for example instructions that when executed by the processor 801, cause processor 801 to be configured or operable to perform one or more operations of a method as described herein. Bus 815 or other communication components may support communication of information within system 800. The interface 811 may be connected to bus 815 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
causing delivery of an instance of main content to a client device;
determining a point of interest in the instance of main content, wherein the point of interest is determined based on a deviation in user experience information for the instance of main content;
determining a plurality of types of deviation for the user experience information associated with the point of interest and metadata for the point of interest;
determining a plurality of types of deliverable content for the point of interest based on the plurality types of deviation;
selecting one of the plurality of types of deliverable content for the point of interest;
causing a delivery of one of the plurality of types of deliverable content based on when the point of interest is displayed in the instance of main content;
determining feedback information for the point of interest based on multiple deliveries of the plurality of types of deliverable content; and
selecting a type of deviation from the plurality of types of deviation for the point of interest based on the feedback information.

2. The method of claim 1, wherein the deliverable content is displayed before the point of interest is reached during playback of the instance of main content or when the point of interest is reached during playback of the instance of main content.

3. The method of claim 1, wherein types of deviation in the plurality of types of deviation are determined based on the user experience information that is associated with the respective point of interest.

4. The method of claim 1, wherein the point of interest is determined based on a drop in viewership of the instance of main content.

5. The method of claim 1, wherein the point of interest is determined based on rewinding events to rewind the instance of main content or fast forward events to fast forward the instance of main content.

6. The method of claim 1, further comprising:
adjusting a probability based on the feedback information; and
comparing the probability to a threshold to automatically select the type of deviation from the plurality of types of deviation.

7. A method comprising:
determining user experience information for an instance of main content, wherein the user experience information is based on user experience of users while displaying the instance of main content;
analyzing the user experience information to determine a point of interest in the instance of main content;
determining a type for the point of interest based on a deviation in the user experience information;
retrieving metadata for the point of interest, wherein the metadata is based on content in the instance of main content that is associated with the point of interest;
determining deliverable content for the point of interest based on the type and the metadata for the point of interest;
causing delivery of deliverable content based on when the point of interest is displayed in the instance of main content;
determining feedback information for the point of interest based on display of the deliverable content; and
determining an adjustment of the deliverable content based on the feedback information.

8. The method of claim 7, further comprising:
sending the deliverable content for the point of interest during playback of the instance of main content.

9. The method of claim 8, further comprising:
sending the deliverable content based on a display of the point of interest.

10. The method of claim 7, wherein determining user experience information comprises:
determining user experience information for a metric that is associated with delivering of the instance of main content over a duration of the instance of main content; and
selecting the point of interest based on the deviation from the user experience information and a prediction of the metric.

11. The method of claim 10, wherein:
the metric is based on a number of users that are viewing the instance of main content over the duration of the instance of main content; and
the deviation is a difference between the user experience information and a prediction of the number of users.

12. The method of claim 10, wherein:
a window of a first time period in the instance of main content is used to determine the prediction of the metric in a second time period; and
the user experience information in the second time period is compared to the prediction in the second time period to determine the deviation.

13. The method of claim 7, wherein determining user experience information comprises:
determining a set of user experience information for a set of other instances of content;
determining the user experience information by combining the set of user experience information; and
selecting the point of interest based on a deviation from the user experience information and a prediction of the user experience information.

14. The method of claim 7, wherein the point of interest is determined based on a drop in viewership of the instance of main content.

15. The method of claim 7, wherein the point of interest is determined based on rewinding events to rewind the instance of main content or fast forward events to fast forward the instance of main content.

16. The method of claim 7, wherein determining the type for the point of interest comprises:
analyzing the user experience information for the point of interest; and
classifying the point of interest based on a type of user experience information that is associated with the point of interest.

17. The method of claim 7, wherein determining the deliverable content comprises:
determining information from the instance of main content for the point of interest; and
inputting the information into a model to generate the deliverable content.

18. The method of claim 7, wherein determining the type for the point of interest comprises:
determining a plurality of types of deliverable content that correspond to different types for the point of interest;
delivering the types of deliverable content to multiple users that are watching the instance of main content; and
analyzing feedback of user experience information from the multiple users to determine one of the types of delivery content to associate the type with the point of interest.

19. The method of claim 18, further comprising:
adjusting a probability based on the feedback information; and
comparing the probability to a threshold to automatically select the type of deliverable content to associate the type with the point of interest.

20. A non-transitory computer-readable storage medium having stored thereon computer executable instructions, which when executed by a computing device, cause the computing device to be operable for:
determining user experience information for an instance of main content, wherein the user experience information is based on user experience of users while displaying the instance of main content;
analyzing the user experience information to determine a point of interest in the instance of main content;
determining a type for the point of interest based on a deviation in the user experience information;
retrieving metadata for the point of interest, wherein the metadata is based on content in the instance of main content that is associated with the point of interest;
determining deliverable content for the point of interest based on the type and the metadata for the point of interest;
causing delivery of deliverable content based on when the point of interest is displayed in the instance of main content;
determining feedback information for the point of interest based on display of the deliverable content; and
determining an adjustment of the deliverable content based on the feedback information.
